(19) United States
(12) Patent Application Publication
(10) Pub. No.: US 2015/0240029 A1
(43) Pub. Date: Aug. 27, 2015

(54) Polyester

(71) Applicant: Clariant Finance (BVI) Limited, Tortola (VG)

(72) Inventors: Dirk Fischer, Klein-Winternheim (DE); Roman Morschhaeuser, Mainz (DE); Peter Naumann, Taunusstein (DE); Antonella Leone-Kammler, Munchestein (CH); John Stuart Cowman, Bradford (GB); Achim Kohler, Heilbronn (DE)

(73) Assignee: Clariant Finance (BVI) Limited, Tortola (VG)

(21) Appl. No.: 14/421,963

(22) PCT Filed: Aug. 14, 2013
(86) PCT No.: PCT/EP2013/002452

§ 371 Date: Feb. 16, 2015

(30) Foreign Application Priority Data
Aug. 18, 2012 (DE) 10 2012 016 444.0

(51) Int. Cl. C08G 63/672

(52) U.S. Cl. CPC C08G 63/672

(57) ABSTRACT

The present invention relates to polyester that can be obtained by polymerization of a) terephtalacid dimethylester, and b) ethylene glycol, and c) 1,2-propylene glycol, and d) one or a plurality of polyethylene glycols having weight average molecular weights in the range of 1,000 to 2,000 g/mol, and e) one methyl polyethylene glycol having a weight average molecular weight in the range of 1,050 to 1,350 g/mol, f) either when a plurality of compounds having a reticulating effect and 3 to 6 functions that are enabled for polycondensation are present or absent. The polyester according to the invention can be used in an advantageous manner, e.g. to modify hydrophobic surfaces, which can be used, e.g., in paper recycling.

This invention concerns polyesters comprising units derived from dimethyl terephthalate, ethylene glycol, propylene glycol, polyethylene glycol, polyethylene glycol monomethyl ether (or methyl polyethylene glycol) and optionally crosslinking structural units.

The polyesters of the present invention are very useful for modifying hydrophobic surfaces, in particular for raising the surface tension thereof and hence reducing the affinity of the modified surfaces for hydrophobic chemistries and hence reducing disruptive effects due to deposits on the hydrophobic surfaces. This may be exploited in recycling processes for paper and board for example. The polyesters of the present invention have a high level of affinity for hydrophobic surfaces and have the effect that hydrophobic surfaces become more hydrophilic and hence their wettability is improved.

The polyesters of the present invention are also highly compatible both toxicologically and ecotoxicologically.

Polyesters formed from aromatic dicarboxylic acids, e.g., terephthalic acid, and diols such as alkylene glycol are well known, for example in the context of reducing the tackiness of paper furnishes contaminated with adhesives.

U.S. Pat. No. 5,415,739 describes a method of reducing the tackiness of paper furnishes contaminated with adhesives, which comprises adding to the furnish a water-soluble terpolymer formed from the distillation product of various monomers. Said monomers may be selected from the group consisting of polyethylene glycol, a phthalic ester moiety derived from either a phthalic ester or a phthalic acid and a simple glycol. The phthalic ester moiety may be derived for example from terephthalic acid or dimethyl terephthalate. Antimony trioxide in particular is recited as catalyst for preparing the terpolymers.

Polyesters of this type have also been described as constituents of laundry detergent and cleaning compositions, in particular for use as soil release polymers (SRPs).

DE 10 2008 023 803 describes additives for laundry detergent and cleaning compositions obtained by polycondensing an aromatic dicarboxylic acid and/or C₁-C₄-alkyl esters thereof with ethylene glycol, optionally 1,2-propylene glycol, optionally polyethylene glycol having an average molar mass of 200 to 8000 g/mol, optionally C₁-C₄-alkyl polyalkylene glycol ethers having an average molar mass of 200 to 5000 for the polyalkylene glycol ether and optionally a polyfunctional compound, and extols for example their solid consistency and hydrolysis stability. Explicitly disclosed polyesters are prepared using, for example, polyethylene glycol 6000 and a mixture of methyl polyethylene glycol 750 and methyl polyethylene glycol 2000.

DE 198 26 356 describes oligoesters obtained by polycondensing dicarboxylic acids or esters, ethylene glycol and/or propylene glycol, polyethylene glycol, a water-soluble addition product of an alkylene oxide onto C₁-C₂₄ alcohols and one or more polyols having 3 to 6 hydroxyl groups and used for example as soil release polymers in laundry detergents. Polyesters explicitly disclosed are obtained, for example, from dimethyl terephthalate, ethylene glycol, 1,2-propylene glycol, polyethylene glycol 1500, a mixture of methyl polyethylene glycol 750 and methyl polyethylene glycol 1820 and pentaerythritol.

However, the polyesters described for use in paper recycling processes are often unsatisfactory in outcome.

It is an object of the present invention to provide a novel product for modifying hydrophobic surfaces, in particular for enhancing the surface tension thereof, and for efficiently eliminating or significantly reducing deposits of undesired adhesive residues in the paper recycling process.

It has now been found that, surprisingly, this problem is solved by polyesters obtainable by polymerization of
a) dimethyl terephthalate, and
b) ethylene glycol, and
c) 1,2-propylene glycol, and
d) one or more polyethylene glycols, preferably one polyethylene glycol, having weight-average molecular weights in the range from 1000 to 2000 g/mol, and
e) one methyl polyethylene glycol having a weight-average molecular weight in the range from 1050 to 1350 g/mol
f) in the presence or absence of one or more crosslinking compounds having 3 to 6 functions capable of polycondensation, especially acid, alcohol or ester functions.

The present invention accordingly provides polyesters obtainable by polymerization of
a) dimethyl terephthalate, and
b) ethylene glycol, and
c) 1,2-propylene glycol, and
d) one or more polyethylene glycols, preferably one polyethylene glycol, having weight-average molecular weights in the range from 1000 to 2000 g/mol, and
e) one methyl polyethylene glycol having a weight-average molecular weight in the range from 1050 to 1350 g/mol
f) in the presence or absence of one or more crosslinking compounds having 3 to 6 functions capable of polycondensation, especially acid, alcohol or ester functions.

The polyesters of the present invention are obtainable by transesterification and condensation of components a) to e) in the presence or absence of component f) in the presence of transesterification and condensation catalysts of the prior art, such as, preferably, titanium tetraisopropoxide/sodium acetate, dibutyltin oxide, or alkali metal or alkaline earth metal alkoxides. It is advantageous that the polyesters of the present invention are obtainable without use of Sb₂O₃ as catalyst, which is classed as a possible carcinogen.

The polyesters of the present invention are notable for not containing residual monomers selected from polyethylene glycols and methyl polyethylene glycols having weight-average molecular weights below 1000 g/mol, which are toxicologically and ecotoxicologically undesirable.

It is an essential feature of the present invention that a single methyl polyethylene glycol having a weight-average molecular weight in the range from 1050 to 1350 g/mol is used as monomer and not a mixture of two or more methyl polyethylene glycols. This provides polyesters of narrower molecular weight distribution and improved quality.

Preference for use as component d) is given to one or more compounds selected from polyethylene glycols having weight-average molecular weights in the range from 1200 to 1800 g/mol.

It is particularly preferable to use one polyethylene glycol having a weight-average molecular weight of 1500 g/mol as component d).

It is preferable for component e) to be one methyl polyethylene glycol having a weight-average molecular weight in the range from 1100 to 1300 g/mol.

It is particularly preferable for component e) to be one methyl polyethylene glycol having a weight-average molecular weight of 1250 g/mol.

In one preferred embodiment of the invention, the polyesters of the invention are obtainable by polymerization of components a) to e) in the presence of component D.

Preference for use as component f) is given to compounds selected from the group consisting of citric acid, malic acid, tartaric acid, garlic acid, 2,2-dihydroxymethylpropionic acid, pentaerythritol, glycerol, sorbitol, mannitol, 1,2,3-hexanetriol, benzene-1,2,3-tricarboxylic acid (hemimellitic acid), benzene-1,2,4-tricarboxylic acid (trimellitic acid) and benzene-1,3,5-tricarboxylic acid (trimeric acid).

Compounds selected from the group consisting of pentaerythritol and glycerol are particularly preferred for use as component f).

Pentaerythritol is greatly preferred for use as component f).

In one further preferred embodiment of the invention, the polyesters of the invention are obtainable by polymerization of components a) to e) in the absence of component f).

Preference is given to polyesters of the invention obtainable by polymerization of components a) to e) in the presence or absence of component f) in the following molar ratios, each based on 1 mol of component a):
0.2 to 0.8 mol, preferably 0.3 to 0.7 mol, more preferably 0.4 to 0.6 mol and most preferably 0.5 to 0.6 mol of component b), and
1.0 to 2.0 mol, preferably 1.1 to 1.6 mol, more preferably 1.2 to 1.5 mol and most preferably 1.3 to 1.4 mol of component c), and
0.05 to 2.0 mol, preferably 0.1 to 1.0 mol, more preferably 0.2 to 0.8 mol and most preferably 0.25 to 0.5 mol of component d), and
0.01 to 1.0 mol, preferably 0.05 to 0.8 mol, more preferably 0.1 to 0.5 mol and most preferably 0.11 to 0.3 mol of component e), and
in the presence of 0.00001 to 1.0 mol, preferably 0.00001 to 0.5 mol, more preferably 0.0001 to 0.01 mol and most preferably 0.0002 to 0.01 mol, of component f) or in the absence of component f).

The polyesters preferably have weight-average molecular weights in the range from 700 to 50 000 g/mol, more preferably in the range from 800 to 25 000 g/mol, even more preferably in the range from 1000 to 15 000 g/mol and yet more preferably in the range from 1200 to 12 000 g/mol. Weight-average molecular weight is determined by size exclusion chromatography in aqueous solution by using a calibration with narrowly distributed sodium polyacrylate as standard.

The polyesters of the present invention are preferably obtained by polymerizing components a) to e) in the presence or absence of component f).

The polyesters of the present invention are preferably nonionic polyesters.

In one particularly preferred embodiment of the invention, the polyesters of the invention are obtainable by polymerization of components a) to e) in the presence or absence of component f), wherein the amount of component d) used in the polymerization is <80.0 wt %, preferably <70.0 wt % and more preferably <50.0 wt %, all based on the overall weight of components a) to e) or a) to f) used for the polymerization.

In a further particularly preferred embodiment of the invention, the polyesters of the invention are obtainable by polymerization of components a) to e) in the presence or absence of component f), wherein the amount of structural units derived from component d) in the polyesters of the invention is <80.0 wt %, preferably <70.0 wt % and more preferably <50.0 wt %, all based on the overall weight of the polyesters according to the invention.

In a further particularly preferred embodiment of the invention, the polyesters of the invention are obtainable by polymerization of components a) to e) in the presence or absence of component f), wherein the amount of components d) and e) used for the polymerization is together <80.0 wt % and preferably <70.0 wt %, both based on the overall weight of components a) to e) or a) to f) used for the polymerization.

In a further particularly preferred embodiment of the invention, the polyesters of the invention are obtainable by polymerization of components a) to e) in the presence or absence of component f), wherein the amount of structural units derived from components d) and e) together in the polyesters of the invention is <80.0 wt % and preferably <70.0 wt %, both based on the overall weight of the polyesters according to the invention.

As mentioned, the polyesters of the present invention are very useful for modifying hydrophobic surfaces, in particular for increasing the surface tension thereof, and hence for reducing disruptive effects by deposits on the hydrophobic surfaces, which for example is advantageously exploitable in recycling processes for paper and board.

The present invention accordingly further provides for one or more of the polyesters according to the present invention to be used for modifying hydrophobic surfaces, preferably in recycling processes for paper and board.

The polyesters of the present invention are further very useful for reducing the deposition of undesired adhesive residues, in particular in the paper recycling process.

The present invention accordingly further provides for one or more of the polyesters of the present invention to be used for reducing the deposition of unwanted adhesive residues, in particular in the paper recycling process.

The one or more polyesters according to the present invention are preferably used in the form of aqueous dispersions, for example as an aqueous dispersion in recycling processes for paper and board. The use of an aqueous dispersion has the advantage of easier meterability and improved handleability over the use of the polyesters as such.

The present invention accordingly also provides aqueous dispersions comprising one or more polyesters according to the present invention.

The aqueous dispersions comprise the one or more polyesters of the present invention in an amount of preferably 5.0 to 50.0 wt %, more preferably 10.0 to 30.0 wt % and still more preferably 15.0 to 25.0 wt %, all based on the overall weight of the final aqueous dispersion. In one particularly preferred embodiment of the invention, the aqueous dispersions consist of the one or more polyesters of the present invention and water.

The polyesters of the present invention are notable for an advantageous dispersibility and solubility in water. Aqueous dispersions consisting of the polyesters of the present invention and water have advantageous stability in storage and exhibit little if any sedimenting.

The examples which follow are provided for further elucidation, but not limitation of the invention. Unless explicitly stated otherwise, all percentages are by weight (wt %).

### EXAMPLES

### Preparation of Inventive Polyester 1

A 1-L four-neck flask equipped with KPG stirrer, internal thermometer, Vigreux column, distillation bridge, N₂ supply (5 l/h) and Anschutz-Thiele adapter was initially charged with 164.4 g (0.85 mol) of dimethyl terephthalate, 87.9 g (1.155 mol) of 1,2-propanediol, 29.5 g (0.475 mol) of ethylene glycol, 1.14 g (0.008 mol) of pentaerythritol and 0.75 g (0.0009 mol) of sodium acetate and the reaction mixture was subsequently heated up to 60° C. internal temperature under N₂ blanketing (5 l/h), with stirring at a stirrer speed of 50-100 rpm. The N₂ line was closed and then 0.2 g (0.0007 mol) of titanium tetraisopropoxide was added. Stirrer speed was subsequently raised to 300 rpm and the batch was heated up to an internal temperature of 150° C. in the course of 2 h and to an internal temperature of 200° C. in the course of a further 2 h. The N₂ line was reopened at an internal temperature of 170° C. The reaction mixture was heated at 200° C. for 2 h and the methanol formed was distilled off and condensed in an ice-cooled receiver. The reaction mixture was subsequently cooled down to room temperature and 328.7 g (0.219 mol) of polyethylene glycol 1500 and 137.8 g (0.11 mol) of polyethylene glycol monomethyl ether 1250 were added. The mixture was heated up to 215° C. internal temperature under N₂ blanketing (5 l/h) with stirring at a stirrer speed of 300 rpm, the N₂ line was closed and the pressure was reduced to 150 mbar in the course of 2 h and to 10 mbar in the course of a further 2 h while glycol was distilled off. After supplementary condensation at 215° C. and 10 mbar for 2 h the melt was cooled down to 140-150° C. The system was then vented with N₂ and the hot melt was discharged. A solidified beige polymer melt was obtained.

### Preparation of Comparative Polyester 1:

A 1-L four-neck flask equipped with KPG stirrer, internal thermometer, Vigreux column, distillation bridge, N₂ supply (5 l/h) and Anschütz-Thiele adapter was initially charged with the following starting materials: 41.53 g (0.25 mol) of dimethyl terephthalate, 27.13 g (0.437 mol) of ethylene glycol, 362.5 g (0.29 mol) of methyl polyethylene glycol 1250, 0.5 g of sodium acetate anhydrous (NaOAc) and 0.13 g of titanium tetraisopropoxide (Ti(iPr)₄).

The mixture was heated to about 160° C. (about 15-20 min) and the methanol produced was distilled off. During the distillation, the temperature was gradually raised to 210° C. in the course of 3 h (N₂ (5 l/h) was passed over from an internal temperature of about 180° C.). Methanol was distilled off until the head temperature was below 55° C. (min. 4 h/210° C. subsequent stirring). This was followed by cooling down to 195° C., pressure reduction to 10 mbar in the course of one hour and distillative removal of glycol (head temperature up to about 150° C.). This was followed by supplementary condensation at 10 mbar/195° C. for 4 h (the head temperature was below 75-80° C. at the end). The vacuum was reduced to 5 mbar for 5 min and then the apparatus was vented with N₂ (oil bath below flask, Tᵢ 185-195° C.) and the hot melt was discharged onto a metal tray.

### Measurement of Surface Tensions:

TABLE 1
Surface tension of untreated polyester fiber X
(polyester fiber X is not made of the inventive
polyesters) and of polyester fiber X treated with
a 0.04 wt % aqueous dispersion of inventive
polyester 1 and of comparative polyester 1.

| Polyester fiber X | Surface tension [mN/m] |
|---|---|
| untreated | 45.5 |
| inventive polyester 1 | 61.2 |
| comparative polyester 1 | 53.3 |

instrument: SITA Pro Line T15 bubble pressure tensiometer
setting: Auto Mode
bubble life: 15 ms to 15 s
measurement: at 15 s
sample solution: 0.04 wt % inventive polyester 1 or comparative
   polyester 1
   in distilled water
temperature: 20° C.

### Measurement of Deposits:

TABLE 2
Deposition of a paper stock which contains adhesive
material on a polyester wire a) having an unmodified
surface, b) modified with inventive polyester 1,
c) modified with comparative polyester 1

| | | Polyester | Polyester | | |
|---|---|---|---|---|---|
| | Polyester | wire | wire after 15 | | Reduc- |
| | concen- | before | min contact | Weight | tion in |
| | tration | deposition | time | increase | deposit |
| Sample | [wt %] | [g] | [g] | [mg] | [%] |
| a | 0 | 308.7 | 315.9 | 7.2 | 0 |
| (control) | | | | | |
| b | | | | | |
| (inventive | 0.1 | 311.0 | 311.7 | 0.7 | 90.3 |
| polyester l) | | | | | |
| c | | | | | |
| (comparative | 0.1 | 305.6 | 310.2 | 4.6 | 36.1 |
| polyester l) | | | | | |

The polyester wire used is not made of the inventive polyesters.

An adhesive label consisting of 75 g of paper and 25 g of an acrylic pressure-sensitive adhesive which in turn consists of 80 wt % of poly(2-ethylhexyl acrylate-acrylic acid) copolymer and 20 wt % of styrene-butadiene copolymer is applied to a 10 g pulp sheet from bleached birchwood. This sheet has 750 ml of tap water added to it and is stirred at 50° C. for 2 minutes in a mixer at a high speed to form a homogeneous paper stock. The mixture obtained is bulked with tap water to an overall volume of 1000 ml and split into 200 ml samples.

Inventive polyester 1 and comparative polyester 1 are each made up into 0.1 weight percent solutions with 100 ml of tap water in each case. 3 polyester wires of the Primobond SF brand (Heimbach), measuring 30×50 mm, are weighed out to the nearest decimal. Each polyester wire is dipped for 10 seconds at room temperature either into pure tap water or into the 0.1 weight percent inventive polyester 1 solution or into the 0.1 weight percent comparative polyester 1 solution for 10 seconds at a time and then removed from the tap water or the 0.1 weight percent solutions and placed into an empty 400 ml glass beaker. The 400 ml glass beakers are each filled with 200 ml of paper stock. Each polyester wire, which is either untreated (tap water, control) or else treated (with inventive polyester 1 or comparative polyester 1) in the above-described manner, is placed into the 200 ml sample a), b) or c) and the sample is stirred at 200 revolutions/minute for 15 minutes. The polyester wires are removed from the samples, rinsed off with cold water, air dried and weighed.

The results show that the use of inventive polyester 1 causes a distinctly smaller amount of adhesive to adhere to the polyester wire (90.3% improvement), compared with the untreated polyester wire (0% improvement) or compared with the use of comparative polyester 1 (36.1% improvement).

1. A polyester prepared by polymerization of
a) dimethyl terephthalate, and
b) ethylene glycol, and
c) 1,2-propylene glycol, and
d) at least one polyethylene glycol having a weight-average molecular weight in the range from 1000 to 2000 g/mol, and
e) one methyl polyethylene glycol having a weight-average molecular weight in the range from 1050 to 1350 g/mol
f) in the presence or absence of at least one crosslinking compound having 3 to 6 functions capable of polycondensation.

2. The polyester as claimed in claim 1 wherein it is prepared by polymerization with at least one polyethylene glycol having a weight-average molecular weight in the range from 1000 to 2000 g/mol.

3. The polyester as claimed in claim 1 wherein the at least one polyethylene glycol has a having weight-average molecular weight in the range from 1200 to 1800 g/mol is used in the polymerization as component d).

4. The polyester as claimed in claims 1, wherein at least one polyethylene glycol having a weight-average molecular weight of 1500 g/mol is used in the polymerization as component d).

5. The polyester as claimed in claim 1, one or more of claims 1 wherein one methyl polyethylene glycol having a weight-average molecular weight in the range from 1100 to 1300 g/mol is used in the polymerization as component e).

6. The polyester as claimed in claim 5 wherein one methyl polyethylene glycol having a weight-average molecular weight of 1250 g/mol is used in the polymerization as component e).

7. The polyester as claimed in claim 1, wherein the polyester is prepared by polymerization of components a) to e) in the presence of component f).

8. The polyester as claimed in claim 7 wherein at least one compound selected from the group consisting of citric acid, malic acid, tartaric acid, gallic acid, 2,2-dihydroxymethylpropionic acid, pentaerythritol, glycerol, sorbitol, mannitol, 1,2,3-hexanetriol, benzene-1,2,3-tricarboxylic acid (hemimellitic acid), benzene-1,2,4-tricarboxylic acid (trimellitic acid) and benzene-1,3,5-tricarboxylic acid (trimesic acid) are used in the polymerization as component f).

9. The polyester as claimed in claim 1, wherein the polyester is prepared by polymerization of components a) to e) in the following molar ratios, each based on 1 mol of component a):
0.2 to 0.8 mol of component b), and
1.0 to 2.0 mol of component c), and
0.05 to 2.0 mol of component d), and
0.01 to 1.0 mol of component e),
in the presence of 0.0 to 1.0 mol of component f).

10. The polyester as claimed in claim 9 wherein the polyester is prepared by polymerization of components a) to e) in the following molar ratios, each based on 1 mol of component a):
0.3 to 0.7 mol of component b), and
1.1 to 1.6 mol of component c), and
0.1 to 1.0 mol of component d), and
0.05 to 0.8 mol of component e),
in the presence of 0.0 to 0.5 mol of component f.

11. The polyester as claimed in claim 10 wherein the polyester is prepared by polymerization of components a) to e) in the following molar ratios, each based on 1 mol of component a):
0.4 to 0.6 mol of component b), and
1.2 to 1.5 mol of component c), and
0.2 to 0.8 mol of component d), and
0.1 to 0.5 mol of component e),
in the presence of 0.0 to 0.01 mol of component f.

12. The polyester as claimed in claim 1, wherein the polyester has a weight-average molecular weight in the range from 700 to 50 000 g/mol.

13. The polyester as claimed in claim 12 wherein the polyester has a weight-average molecular weight in the range from 1000 to 15 000 g/mol.
